(19) United States
(12) Patent Application Publication
(10) Pub. No.: US 2009/0304044 A1
(43) Pub. Date: Dec. 10, 2009

(54) FREQUENCY-HOPPING ARRANGEMENT

(75) Inventors: Remco Cornelis Herman Van De Beek, Eindhoven (NL); Dominicus Martinus Wilhelmus Leenaerts, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/814,002

(22) PCT Filed: Jan. 10, 2006
(86) PCT No.: PCT/IB06/50084

§ 371 Date: Jul. 16, 2007

(30) Foreign Application Priority Data
Jan. 17, 2005 (EP) 05100242.6

(51) Int. Cl. H04B 1/713

(52) U.S. Cl. 375/132; 375/135; 375/E01.033; 375/E01.034

(57) ABSTRACT

A frequency-hopping arrangement comprises a basic-frequency branch (DIV1), an offset-frequency branch (DIV2, DIV3, SCC), and a controllable frequency converter (SBM, FSC). The basic-frequency branch (DIV1) receives an oscillator signal (OS) having an oscillator-signal frequency (7920 MHz). The basic-frequency branch has a frequency-division factor (/2) so as to provide a basic-frequency signal (BF) having a basic frequency (+3960 MHz) that is the oscillator-signal frequency divided by the frequency-division factor. The offset-frequency branch (DIV2, DIV3, SCC) receives the same oscillator signal (OS). The offset-frequency branch has a different frequency-division factor (/3, /5) so as to provide an offset-frequency signal (OF) having an offset frequency (+528 MHz) that is the oscillator-signal frequency divided by the different frequency-division factor. The controllable frequency converter (SBM, FSC) provides a frequency-hopping signal (FHS) having a frequency (cl*+3960+c2*+528 MHz) that is a linear combination of the basic frequency and the offset frequency with at least one coefficient (c2) that varies as a function of a hopping-control signal (HCS).

An aspect of the invention relates to a frequency-hopping arrangement. The frequency-hopping arrangement may be used, for example, in an ultra-wide band (UWB) system that establishes a wireless link via which the two apparatuses can exchange data. Other aspects of the invention relate to a method of frequency hopping, a wireless-link system, and an information-rendering apparatus. The information-rendering apparatus may be, for example, a personal computer or a video projector.

United States patent application published under number 2004/0136441 describes a frequency-hopping system. The frequency-hopping system comprises a frequency hopper for outputting signals with temporarily varied frequencies according to a predetermined pattern. The frequency hopper includes a direct digital synthesizer (DDS). A fixed phaselock loop outputs frequency-fixed signals. A mixer mixes the output signals of the frequency hopper and the fixed phaselock loop. The mixer outputs frequency-hopped local signals, which are applied to a modulator.

According to an aspect of the invention, a frequency-hopping arrangement comprises a basic-frequency branch, an offset-frequency branch and a controllable frequency converter. The basic-frequency branch receives an oscillator signal having an oscillator-signal frequency. The basic-frequency branch has a frequency-division factor so as to provide a basic-frequency signal having a basic frequency that is the oscillator-signal frequency divided by the frequency-division factor. The offset-frequency branch receives the same oscillator signal. The offset-frequency branch has a different frequency-division factor so as to provide an offset-frequency signal having an offset frequency that is the oscillator-signal frequency divided by the different frequency-division factor. The controllable frequency converter provides a frequency-hopping signal having a frequency that is a linear combination of the basic frequency and the offset frequency with at least one coefficient that varies as a function of a hopping-control signal.

A frequency-hopping arrangement in accordance with the invention allows generation of a frequency-hopping signal on the basis of a single oscillator signal only. One oscillator, or signal generator, is sufficient. In contradistinction, the prior art requires two signal generators: a direct digital synthesizer and a phaselock loop. There is a cost associated with each signal generator, which may be expressed in terms of surface area in integrated circuit implementations. Moreover, each signal generator requires a certain design effort, which also represents costs. In addition, each signal generator consumes power. Since the invention requires a single signal generator only, which may be a relatively simple oscillator, the invention allows cost reduction. In addition, the invention allows power-consumption reduction.

Another advantage of the invention relates to the following aspects. Let it be assumed that a signal-processing circuit comprises two different signal generators, which is the case in the prior art. In practice, there will be a certain parasitic signal leakage from one signal generator to the other. There is a certain signal-generator crosstalk. One signal generator will influence the other in an undesired manner, and vice versa. The result is that each signal generator will provide a signal that comprises spurious components. Such spurious components may degrade signal-processing quality. For example, the spurious components may introduce interference in a desired signal. As mentioned hereinbefore, the invention allows generation of a frequency-hopping signal on the basis of a single oscillator signal only. Consequently, the invention avoids signal-generator crosstalk, which contributes to satisfactory signal-processing quality.

These and other aspects of the invention will be described in greater detail hereinafter with reference to drawings.

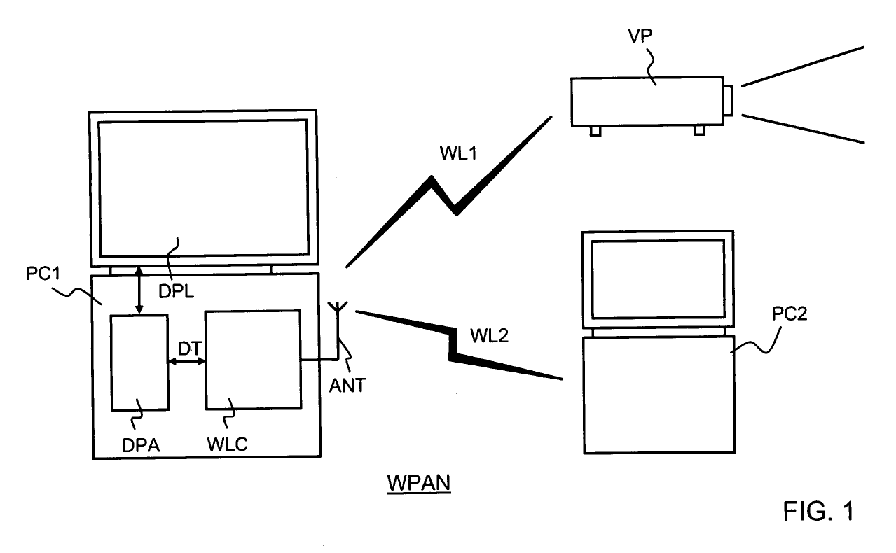

FIG. 1 is a block diagram that illustrates a wireless personal-area network.

FIG. 2 is a frequency diagram that illustrates a frequency spectrum of a wireless link in the wireless personal-area network.

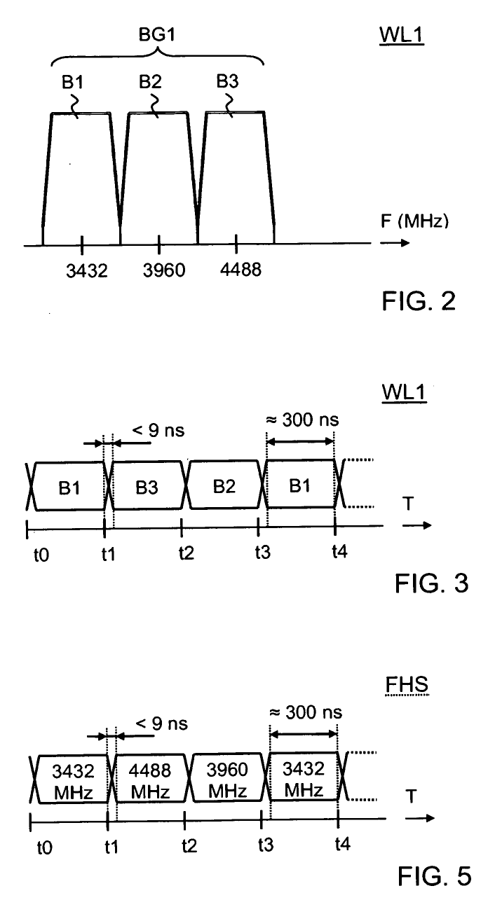

FIG. 3 is a time diagram that illustrates a frequency-band occupation of the wireless link.

FIG. 4 is a block diagram that illustrates a wireless-link circuit that forms part of the wireless personal-area network.

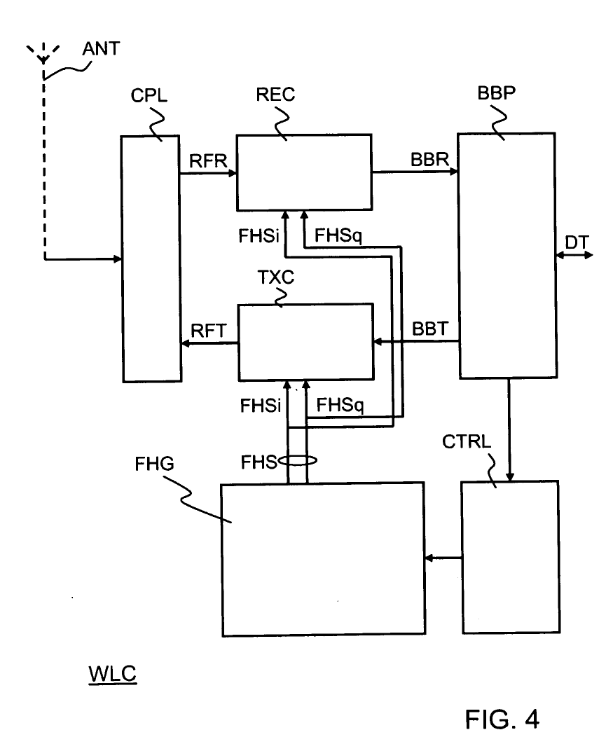

FIG. 5 is a time diagram that illustrates a frequency-hopping signal associated with the frequency-band occupation illustrated in FIG. 3.

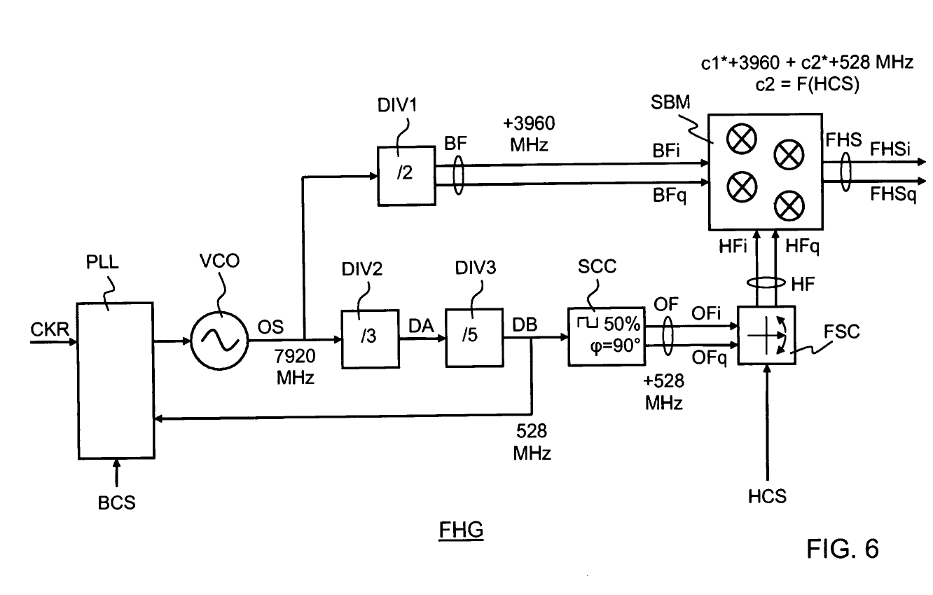

FIG. 6 is a block diagram that illustrates a frequency-hopping generator that forms part of the wireless-link circuit.

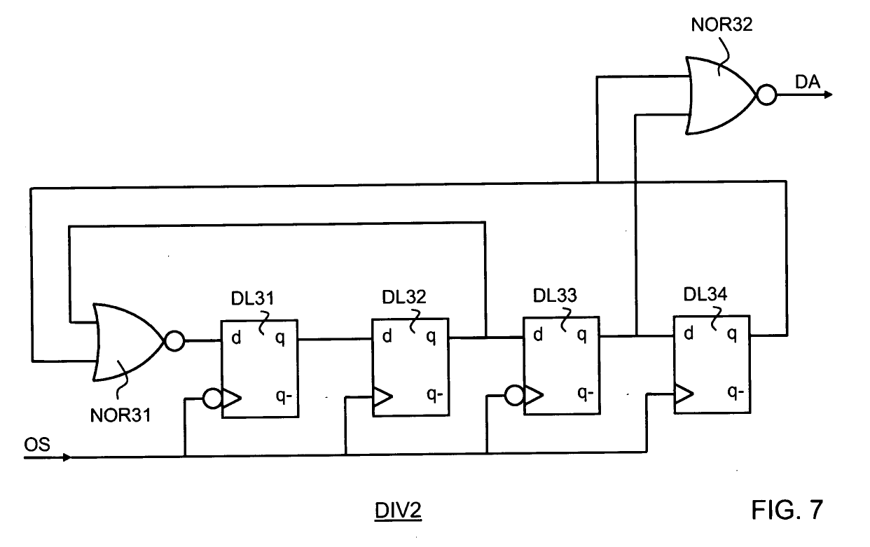

FIG. 7 is a circuit diagram that illustrates a divider that forms part of the frequency-hopping generator.

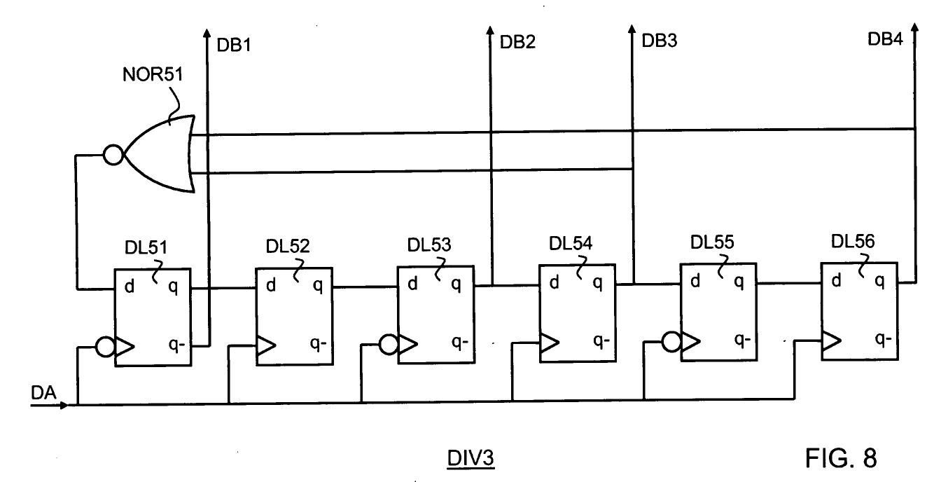

FIG. 8 is a circuit diagram that illustrates another divider that forms part of the frequency-hopping generator.

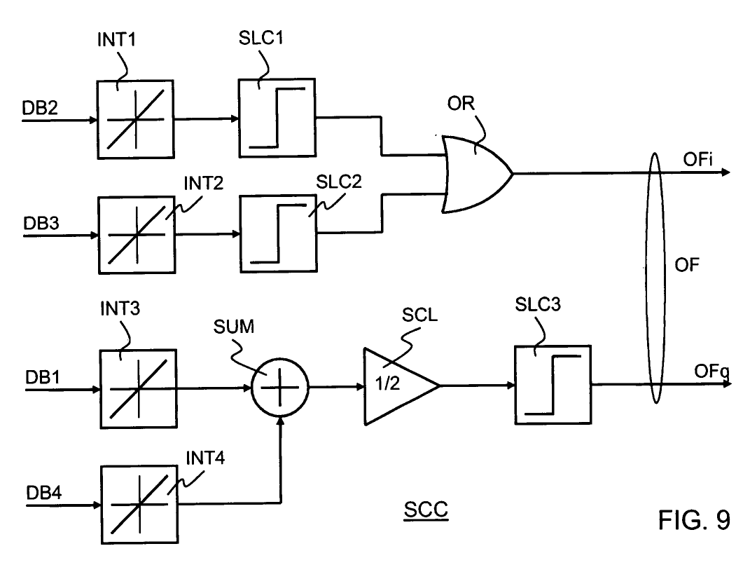

FIG. 9 is a block diagram that illustrates a signal-conditioning circuit that forms part of the frequency-hopping generator.

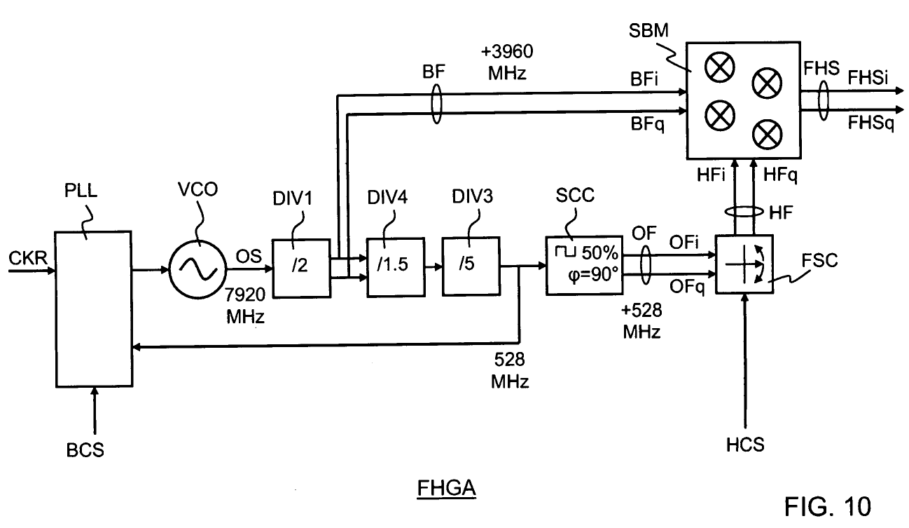

FIG. 10 is a block diagram that illustrates an alternative frequency-hopping generator.

FIG. 1 illustrates a wireless personal-area network WPAN. The wireless personal-area network WPAN comprises a personal computer PC1, a video projector VP, and another personal computer PC2. The personal computer PC1 comprises a display device DPL, a data-processing arrangement DPA, and a wireless link circuit WLC, which is coupled to an antenna ANT. The video projector VP and the other personal computer PC2 each comprise a wireless-link circuit comparable with the wireless-link circuit WLC in the personal computer PC. Accordingly, the personal computer PC1 can establishes a wireless link WL1 with the video projector VP and another wireless link WL2 with the other personal computer PC2.

The wireless links WL1 and WL2 allow the data-processing arrangement DPA to exchange data DT with the video projector VP and with the other personal computer PC2, respectively. For example, the data-processing arrangement DPA may send successive slides that form a slide show to the video projector VP. The video projector VP thus receives a slide via the wireless link WL1 and displays the slide. The wireless link WL1 may replace, for example, a universal serial bus connection which would otherwise be needed to transfer slides from the personal computer PC1 to the video projector VP.

The personal computer PC1 may receive data from the other personal computer PC2 via the other wireless link WL2. This data may comprise, for example, an image to be displayed. The data-processing arrangement DPA receives the image via the wireless-link circuit WLC and causes the display device DPL to display the image, which originates from the other personal computer PC2. A cable connection between the personal computer PC and the other personal computer PC is not required.

FIG. 2 illustrates a frequency spectrum of the wireless link WL1. The frequency spectrum comprises three frequency bands B1, B2, and B3. A first frequency band B1 is centered on 3432 MHz. A second frequency band B2 is centered on 3960 MHz. A third frequency band B3 is centered on 4488 MHz. These three frequency bands B1, B2, and B3 constitute a band group BG1. At any given instant, the wireless link WL1 occupies one of the three frequency bands B1, B2 or B3 only. The wireless link WL1 does not occupy the three frequency bands B1, B2, and B3 simultaneously. However, throughout a relatively long interval time, the wireless link WL1 alternately occupies each of the three frequency bands B1, B2, and B3. The same applies to the other wireless link WL2.

FIG. 3 illustrates a frequency-band occupation of the wireless link WL1. In a time interval between instant t0 and t1, the wireless link WL1 occupies the first frequency band B1. In a time interval between instant t1 and t2, the wireless link WL1 occupies the third frequency band B3. In a time interval between instant t2 and t3, the wireless link WL1 occupies the second frequency band B2. In a time interval between instant t3 and t4, the wireless link WL1 occupies the first frequency band B1 again.

FIG. 3 thus illustrates a particular frequency-band occupation pattern. The other wireless link WL2 has a different frequency-band occupation pattern. Accordingly, the one and the other wireless link, WL1 and WL2, can be distinguished from each other although they share the same frequency spectrum.

FIG. 3 further illustrates that a switch from one to another frequency band takes a certain time. A band switch is not instantaneous. Preferably, each band switch should be relatively fast. FIG. 3 illustrates a band-switching window that should be less than 9 nanoseconds. FIG. 3 further illustrates that the wireless link WL1 occupies a frequency band for approximately 300 nanoseconds, where after a band switch may take place. That is, a frequency-band occupation window of approximately 300 nanoseconds characterizes the frequency-band occupation pattern, which FIG. 3 illustrates. In this example, the band-switching window should thus preferably be less than 3% of the frequency-band occupation window.

FIG. 4 illustrates the wireless-link circuit WLC, which forms part of the personal computer PC1 illustrated in FIG. 1. The wireless-link circuit WLC comprises an antenna coupler CPL, a receiver circuit REC, a transmitter circuit TXC, and a baseband processor BBP. The antenna ANT, which was already shown in FIG. 1, is also illustrated in broken lines. The wireless-link circuit WLC further comprises a frequency-hopping generator FHG and a controller CTRL. The frequency-hopping generator FHG determines the frequency band that the wireless link WL1 occupies at a given instant. Consequently, the frequency-hopping generator FHG forms the heart of the wireless-link circuit WLC.

The wireless-link circuit WLC operates as follows. In a reception mode, the antenna coupler CPL transfers a radiofrequency spectrum, which the antenna ANT receives, to the receiver circuit REC. Accordingly, a received radio frequency spectrum RFR is present at an input of the receiver circuit REC. The receiver circuit REC further receives a frequency-hopping signal FHS. The frequency-hopping signal FHS has a frequency that, at any given instant, corresponds with one of the following frequencies: 3432 MHz, 3960 MHz, and 4488 MHz. These are the frequencies on which the three frequency bands B1, B2 and B3 are centered as illustrated in FIG. 2.

The receiver circuit REC selects the frequency band that corresponds with the frequency of the frequency-hopping signal FHS. The receiver circuit REC demodulates a signal that is present in that frequency band so as to obtain a baseband reception signal BBR. In effect, the receiver circuit REC is a so-called direct-conversion receiver. The signal, which needs to be demodulated, may be, for example, an orthogonal frequency-division multiplex (OFDM) signal. In that case, the receiver circuit REC may carry out a fsst-fourier transformation (FFT) so as to demodulate the OFDM signal. A correct demodulation may further require frequency, phase and time synchronization. The baseband processor BBP processes the baseband reception signal BBR so as to obtain the data DT that has been transferred via the wireless link of interest. Such processing may comprise de-interleaving, Viterbi decoding, and descrambling.

In a transmission mode, the baseband processor BBP processes the data DT to be transferred via the wireless link of interest. Such processing is typically complementary with the processing that the baseband processor BBP carries out in the reception mode. For example, in the transmission mode, the baseband processor BBP may carry out interleaving, Viterbi encoding, and scrambling. The baseband processor BBP provides a baseband transmission signal BBT, which is result of the processing of the data DT to be transferred via the wireless link WL1 of interest. The transmitter circuit TXC modulates the baseband transmission signal BBT so as to obtain a radiofrequency transmission signal RFT. The radiofrequency transmission signal RFT is centered on the frequency of the frequency-hopping signal FHS. The radiofrequency transmission signal RFT may lie within any of the three frequency bands B1, B2, or B3, illustrated in FIG. 2. At any given instant, the radiofrequency transmission signal RFT lies within the frequency band centered on the frequency that the frequency-hopping signal FHS has at that given instant.

The frequency-hopping generator FHG provides the frequency-hopping signal FHS in the form of a quadrature signal, which has an in-phase component FHSi and a quadrature component FHSq. Such a signal is particularly suited for a direct frequency conversion, which the receiver circuit REC and the transmitter circuit TXC carry out. A quadrature signal allows a distinction between positive and negative frequencies. Accordingly, the receiver circuit REC can determine, as it were, if a particular frequency in the received radio frequency spectrum RFR is above or below the frequency of the frequency-hopping signal FHS. The transmitter circuit TXC can frequency shift the baseband transmission signal BBT in a spurious-free manner so as to obtain the radiofrequency transmission signal RFT.

The controller CTRL applies control signals to the frequency-hopping generator FHG. An arrow symbolizes this in FIG. 4. The frequency of the hopping signal varies as a function of these control signals. Accordingly, the controller CTRL can cause the wireless-link circuit WLC to exhibit a frequency-band occupation pattern, such as, for example, as illustrated in FIG. 3. The frequency-band occupation pattern may be derived from, for example, information comprised in the data DT received via the wireless link of interest. An arrow, which extends from the baseband processor BBP to the controller CTRL, symbolizes this in FIG. 4.

FIG. 5 illustrates the frequency-hopping signal FHS associated with the frequency-band occupation pattern illustrated in FIG. 3. In the time interval between instant to and t1, the frequency of the frequency-hopping signal FHS is 3432 MHz. In the time interval between instant t1 and t2, the frequency of the frequency-hopping signal FHS is 4488 MHz. In the time interval between instant t2 and t3, the frequency of the frequency-hopping signal FHS is 3960 MHz. In the time interval between instant t3 and t4, the frequency of the frequency-hopping signal FHS is 3432 MHz.

FIG. 5 further illustrates that the frequency-hopping generator FHG needs to switch frequency in a relatively short time, for example, within 9 nanoseconds. Furthermore, the frequency of the frequency-hopping signal FHS needs to be accurate and stable throughout each frequency-band occupation window. These are conflicting requirements.

FIG. 6 illustrates the frequency-hopping generator FHG, which can meet the aforementioned requirements. The frequency-hopping generator FHG comprises a phaselock-loop circuit PLL, a controllable oscillator VCO, three frequency dividers DIV1, DIV2, DIV3, a signal-conditioning circuit SCC, a frequency-selection circuit FSC, and a single-sideband mixer SBM. In combination, the single-sideband mixer SBM and the frequency-selection circuit FSC constitute a controllable frequency converter. Two different branches extend from the controllable oscillator VCO to the controllable frequency converter: a first branch that comprises frequency divider DIV1, and a second branch that comprises frequency dividers DIV2, DIV3 and the signal-conditioning circuit SCC.

Frequency-hopping generator FHG operates as follows. The controllable oscillator VCO provides an oscillator signal OS having a frequency of approximately 7920 MHz. Frequency divider DIV1 divides this frequency by two so as to obtain a basic-frequency signal BF. The basic-frequency signal BF is a quadrature signal having an in-phase component BFi and a quadrature component BFq. It has been mentioned hereinbefore that a quadrature signal allows a distinction between positive and negative frequencies. Consequently, the basic-frequency signal BF may have a frequency that is −3960 MHz or +3960 MHz. This is a matter of circuit design. It is sufficient to interchange two connections inside frequency divider DIV1 in order to toggle the sign of the frequency. It will be assumed hereinafter that the frequency of the basic-frequency signal BF is +3960 MHz.

Frequency divider DIV2 divides the frequency of the oscillator signal OS by three. Accordingly, frequency divider DIV2 provides a divided-by-3 oscillator signal DA. The divided-by-3 oscillator signal DA has a duty cycle that is 50%. Frequency divider DIV3 divides the frequency of the divided-by-3 oscillator signal DA by five. Frequency divider DIV3 provides a set of four divided-by-15 oscillator signals DB, each having a frequency of 528 MHz. Each of the four divided-by-15 oscillator signals has a different phase.

The signal-conditioning circuit SCC provides an offset-frequency signal OF on the basis of the set of four divided-by-15 oscillator signals DB. The offset-frequency signal OF is a quadrature signal having an in-phase component OFi and a quadrature component OFq. Moreover, the signal-conditioning circuit SCC provides the offset-frequency signal OF so that each of these two components OFi, OFq has a duty cycle that is 50%. The offset-frequency signal OF may have a frequency that is −528 MHz or +528 MHz. This is a matter of circuit design. It is sufficient to interchange two connections inside the signal-conditioning circuit SCC in order to toggle the sign of the frequency. It will be assumed hereinafter that the frequency of the offset-frequency signal OF is +528 MHz.

The frequency-selection circuit FSC applies an input signal HF to the single-sideband mixer SBM. The input signal HF can be any one of the following three signals: the offset-frequency signal OF, the offset-frequency signal OF with the in-phase and quadrature component being interchanged, or a direct-current signal. The frequency-selection circuit FSC receives a hopping-control signal HCS that determines which one of the aforementioned three signals is applied to the single-sideband mixer SBM. For example, the hopping-control signal HCS may have the following three states: a non-inverting state, and inverting state, and a neutral state. In the non-inverting state, the single-sideband mixer SBM receives the offset-frequency signal OF. In the inverting state the single-sideband mixer SBM receives the offset-frequency signal OF with the in-phase and quadrature component being interchanged. In the neutral state, the single-sideband mixer SBM receives the direct-current signal.

It should be noted that interchanging the in-phase and quadrature component of a quadrature signal, corresponds with inverting the frequency spectrum of the quadrature signal. A negative frequency becomes a positive frequency, and vice versa. The offset-frequency signal OF has a frequency of +528 MHz. The input signal HF, which the single-sideband mixer SBM receives, will be −528 MHz if the frequency-selection circuit FSC interchanges the in-phase and quadrature component A direct-current signal corresponds with “zero” frequency.

The single-sideband mixer SBM mixes the basic-frequency signal BF with the input signal HF received from the frequency-selection circuit FSC. To that end, the single-sideband mixer SBM comprises two quadrature mixers. A first quadrature mixer mixes the in-phase component BFi of the basic-frequency signal BF with the input signal HF received from the frequency-selection circuit FSC. A second quadrature mixer mixes the quadrature component BFq of the basic-frequency signal BF with the input signal HF received from the frequency-selection circuit FSC. Each quadrature mixer comprises a pair of mixer circuits. One mixer circuit receives the in-phase component HFi of the input signal HF; the other mixer circuit receives the quadrature component HFq of the input signal HF.

The frequency of the frequency-hopping signal FHS, which the single-sideband mixer SBM provides, is a linear combination of the frequency of the basic-frequency signal BF, which is +3960 MHz, and the frequency of the offset-frequency signal OF, which is +528 MHz. In a mathematical expression, the frequency of the frequency-hopping signal FHS is equal to c1*Fb+c2*Fo. In this expression, Fb denotes the frequency of the basic-frequency signal BF, Fo denotes the frequency of the offset-frequency signal OF, and c1 and c2 are coefficients.

In the aforementioned mathematical expression, coefficient c1 is a fixed coefficient that is either −1 or +1 depending on mixer-circuit connections within the single-sideband mixer SBM. This is a matter of design. Interchanging two connections inside the single-sideband mixer SBM is sufficient to make coefficient c1 toggle sign. It is assumed hereinafter that coefficient c1=+1.

Coefficient c2 is a controllable coefficient that is either −1, 0, or +1 depending on the hopping-control signal HCS. It has been mentioned hereinbefore that the hopping-control signal HCS has a non-inverting state, an inverting state, and a neutral state. The respective values that coefficient c2 will have in these respective states is a matter of design. For example, the single-sideband mixer SBM can be designed so that coefficient c2=−1, 0, or +1 when the hopping-control signal HCS is in the inverting state, the neutral state, and the non-inverting state, respectively. This will be assumed to be the case hereinafter. However, it is sufficient to interchange two connections in order that coefficient c2=−1, 0, or +1 when the hopping-control signal HCS is in the in non-inverting state, the neutral state, and the inverting state, respectively.

Accordingly, the frequency of the frequency-hopping signal FHS is +1*+3960−1*528=3432 MHz when the hopping-control signal HCS is in the inverting state. In that state, the single-sideband mixer SBM mixes the basic-frequency signal BF, whose frequency is +3960 MHz, with the offset-frequency signal OF with the in-phase and quadrature component being interchanged, whose frequency is −528 MHz.

The frequency of the frequency-hopping signal FHS is +1*+3960−0=3960 MHz when the hopping-control signal HCS is in the neutral state. In that state, the single-sideband mixer SBM mixes the basic-frequency signal BF, whose frequency is +3960 MHz, with the direct current signal, whose frequency is “0”.

The frequency of the frequency-hopping signal FHS is +1*+3960+1*528=4488 MHz when the hopping-control signal HCS is in the non-inverting state. In that state, the single-sideband mixer SBM mixes the basic-frequency signal BF, whose frequency is +3960 MHz, with the offset-frequency signal OF, whose frequency is +528 MHz.

The phaselock-loop circuit PLL synchronizes the oscillator signal OS, which the controllable oscillator VCO provides, with a reference frequency signal CKR. To that end, the phaselock-loop circuit PLL receives a divided-by-15 oscillator signal from frequency divider DIV3. The phaselock-loop circuit PLL further receives a basic control signal BCS that represents a desired frequency ratio between the divided by 15 oscillator signal OS and the reference frequency signal CKR. The phaselock-loop circuit PLL controls the controllable oscillator VCO so that the desired frequency ratio is obtained.

FIG. 7 illustrates a possible implementation of frequency divider DIV2, which divides by 3. Frequency divider DIV2 comprises four latch circuits DL31, DL32, DL33 and DL34 of the “D”-type. Each latch circuit DL has a data input d, and output q, an inverted output q−, and a clock input represented by a triangle. Latch circuits DL31 and DL33 are locked when the respective clock inputs receive a signal level that is ‘1’. In contradistinction, latch circuits DL32 and DL34 are locked when the respective clock inputs receive a signal level that is ‘0’. A small circle, which is in front of the respective clock inputs of latch circuits DL31 and DL33, symbolizes this difference. The oscillator signal OS is applied to each respective clock input.

Frequency divider DIV2 further comprises two nor-gate circuits NOR31 and NOR32. Nor-gate circuit NOR31 forms part of a feedback loop. The feedback loop defines a three-state operation. Divider DIV2 repetitively goes through three different states, which corresponds with a division by 3. Nor-gate circuit NOR2 combines signals from the respective outputs q of latch circuits DL33 and DL34 in accordance with a nor function. Accordingly, the divided-by-3 oscillator signal DA with 50% duty cycle is obtained.

FIG. 8 illustrates a possible implementation of frequency divider DIV3, which divides by 5. Frequency divider DIV3 comprises six latch circuits DL51-DL56 similar to those illustrated in FIG. 7. The divided-by-3 oscillator signal DA is applied to each respective clock input Frequency divider DIV3 further comprises a nor-gate circuit NOR51 that forms part of a feedback loop. The feedback loop defines a five-state operation. Frequency divider DIV3 repetitively goes through five different states, which corresponds with a division by 5.

The inverted output q− of latch circuit DL51 provides a first divided-by-15 oscillator signal DB1. The respective outputs q of latch circuits DL53, DL54, and DL56 provide a second, third, and fourth divided-by-15 oscillator signal DB2, DB3, and DB4, respectively. The first, second, third, and fourth divided-by-15 oscillator signal DB1, DB2, DB3, and DB4 form the set of four divided-by-15 oscillator signals DB, which is applied to the signal-conditioning circuit SCC, as mentioned hereinbefore with reference to FIG. 6.

FIG. 9 illustrates a possible implementation of the signal-conditioning circuit SCC. The signal-conditioning circuit SCC comprises four integrating circuits INT1, INT2, INT3, INT4, three slicing circuits SLC1, SLC2, SLC3, an or-gate circuit OR, a summing circuit SUM, and a scaling circuit SCL. Integrating circuit INT1 receives the second divided-by-15 oscillator signal DB2 as an input signal. Integrating circuit INT2 receives the third divided-by-15 oscillator signal DB3 as an input signal. Integrating circuit INT3 receives the first divided-by-15 oscillator signal DB1 as an input signal. Integrating circuit INT4 receives the fourth divided-by-15 oscillator signal DB4 as an input signal. Each of these divided-by-15 oscillator signals DB1, DB2, DB3 and DB4, has a different phase because these are taken from different points in frequency divider DIV3 as illustrated in FIG. 8.

An integrating circuit INT makes edges, which are present in an input signal, less steep. The integrating circuit INT softens, as it were, transitions within the input signal. The integrating circuit INT provides an output signal in which binary-value transitions, zero-to-one and one-to-zero, are more gradual than in the input signal. Transitions take more time.

A slicing circuit SLC provides an opposite effect The slicing circuit SLC provides a binary zero if an input signal is below a threshold value and a binary one if the input signal is above a threshold value, or vice versa. Let it be assumed that the input signal gradually transits from a low value to a high value. The slicing circuit SLC will provide a sharp binary-value change when the input signal crosses the threshold value.

In combination, integrating circuits INT3 and INT4, the summing circuit SUM, and the scaling circuit SCL provide a phase interpolation between the first and fourth divided-by-15 oscillator signals DB1 and DB4. This phase interpolation is made by softening transitions in these divided-by-15 signals DB1 and DB4. The scaling circuit SCL, which has a gain of 0.5, provides amplitude compensation. Slicing circuit SLC3 restores sharp transitions. Slicing circuit SLC3 provides the quadrature component OFq of the offset-frequency signal OF with 50% duty cycle.

The aforementioned phase interpolation introduces a certain delay. Integrating circuits INT1, INT2 and slicing circuits SLC1, SLC2 compensate for this delay. The or-gate circuit OR provides the in-phase component OFi of the offset-frequency signal OF with 50% duty cycle.

In combination, frequency divider DIV3 and signal-conditioning circuit SCC provide an odd-integer division ratio with a quadrature-signal output having 50% duty cycle. These aspects are described in greater detail in European patent application number * (attorney's docket no. PHNL041253) and any corresponding application, incorporated by reference herein.

The frequency-selection circuit FCS can be realized by means of various switches and, if needed, some switching-control logic. For example, two switches may be coupled between frequency divider DIV3 and single-sideband mixer SBM. One switch is for the in-phase component OFi; the other is for the quadrature component OFq. The two switches are closed when the hopping-control signal HCS is in the non-inverting state. The two switches are open in the other states. Two other switches may be cross coupled so as to interchange the in-phase component OFi and the quadrature component OFq. These two switches are closed when the hopping control signal HCS is in the inverting state, but are open in the other states. Yet two other switches may be coupled between a direct-current source and the single-sideband mixer SBM. These two switches are closed when the hopping control signal is in the neutral state, but are open in the other states.

FIG. 10 illustrates an alternative frequency-hopping generator FHGA. The alternative frequency-hopping generator FHGA comprises the same elements as the frequency-hopping generator FHG, which has been described hereinbefore with reference to FIG. 6. There is one exception. Frequency divider DIV2, which is present in FIG. 6, has been replaced by frequency divider DIV4. Frequency divider DIV4 receives an input signal from frequency divider DIV1 rather than from the controllable oscillator VCO. In the alternative frequency-hopping generator FHGA, the controllable oscillator VCO has to furnish the oscillator signal OS to frequency divider DIV1 only. Consequently, the controllable oscillator VCO has a lesser load, which is an advantage.

Frequency divider DIV4 has a frequency-division factor of 1.5. Since frequency divider DIV4 receives the basic-frequency signal BF, which is a divided-by-2 oscillator signal OS, frequency divider DIV4 provides a divided-by-3 oscillator signal. This signal is comparable with the divided-by-3 oscillator signal DA in the frequency-hopping generator FHG illustrated in FIG. 6. The basic-frequency signal BF is a quadrature signal, which allows frequency divider DIV4 to provide the divided-by-3 oscillator signal with a 50% duty cycle.

### Concluding Remarks:

The detailed description hereinbefore with reference to the drawings illustrates the following characteristics (claim 1). A frequency-hopping arrangement comprises a basic-frequency branch (DIV1), an offset-frequency branch (FIG. 6: DIV2, DIV3, SCC; FIG. 10: DIV1, DIV4, DIV3, SCC) and a controllable frequency converter (SBM, FSC). The basic-frequency branch (DIV1) receives an oscillator signal (OS) having an oscillator-signal frequency (7920 MHz). The basic-frequency branch has a frequency-division factor (/2) so as to provide a basic-frequency signal (BF) having a basic frequency (+3960 MHz) that is the oscillator-signal frequency divided by the frequency-division factor. The offset-frequency branch (DIV2, DIV3, SCC) receives the same oscillator signal (OS). The offset-frequency branch has a different frequency-division factor (/3, /5) so as to provide an offset-frequency signal (OF) having an offset frequency (+528 MHz) that is the oscillator-signal frequency divided by the different frequency-division factor. The controllable frequency converter (SBM, FSC) provides a frequency-hopping signal (FHS) having a frequency (c1*+3960+c2*+528 MHz) that is a linear combination of the basic frequency and the offset frequency with at least one coefficient (c2) that varies as a function of a hopping-control signal (HCS).

The detailed description hereinbefore further illustrates the following optional characteristics (claim 2). The offset-frequency branch (DIV2, DIV3, SCC) is arranged to provide the offset-frequency signal (OF) in the form of a quadrature signal having an in-phase component (OFi) and a quadrature component (OFq). The controllable frequency converter (SBM, FSC) comprises a frequency selector (HCS) and a quadrature mixer (SBM). The frequency selector provides a mixer-input signal (H) that corresponds with the offset-frequency signal (OF) when the hopping-control signal (HCS) is in a non-inverting state, and that corresponds with the offset-frequency signal with the in-phase and quadrature component being interchanged when the hopping-control signal is in an inverting state. The quadrature mixer (SBM) mixes the mixer-input signal with the basic frequency signal (BF). These characteristics allow cost-efficient implementations.

The detailed description hereinbefore further illustrates the following optional characteristics (claim 3). The frequency selector (FSC) provides a direct-current signal as the mixer-input signal (HF) when the hopping-control signal (HCS) is in a neutral state. This allows the basic frequency to be one of the frequencies that the frequency-hopping signal may have.

The detailed description hereinbefore further illustrates the following optional characteristics (claim 4). The basic-frequency branch (DIV1) provides the basic-frequency signal (BF) in the form of a quadrature signal having an in-phase component (BFi) and a quadrature component (BFq). The controllable frequency converter (SBM, FSC) comprises a pair of quadrature mixers (SBM) for mixing the mixer-input signal (HF) with the basic frequency signal. These characteristics allow an electronic suppression of so-called image-frequency signals, which alleviates filter requirements. Consequently, these characteristics allow cost-efficient implementations.

The detailed description hereinbefore further illustrates the following optional characteristics (claim 5). The offset-frequency branch (DIV2, DIV3, SCC) provides the offset-frequency signal (OF) with a fifty percent duty cycle. This contributes to the frequency-hopping signal being spurious-free.

The detailed description hereinbefore further illustrates the following optional characteristics (claim 6). The offset-frequency branch (DIV2, DIV3, SCC) comprises an input circuit (DIV2) that provides a frequency-divided signal (DA) with a fifty percent duty cycle on the basis of the oscillator signal (OS). An output circuit (DIV3, SCC) provides the offset frequency signal (OF), which has the in-phase component (OFi) and the quadrature component (OFq), on the basis of the frequency-divided signal (DA). These characteristics allow the offset-frequency branch to have an odd-integer division ratio and a quadrature signal output in a cost-efficient manner.

The detailed description hereinbefore further illustrates the following optional characteristics (claim 7). A controllable oscillator (VCO) provides the oscillator signal (OS). A phase-lock loop circuit (PLL) synchronizes the oscillator signal with a reference-frequency signal (CKR). This contributes to the frequency-hopping signal being accurate in terms of frequency and, if needed, phase.

The detailed description hereinbefore further illustrates the following optional characteristics (claim 8). The basic-frequency branch (DIV1) and the offset-frequency branch (FIG. 10: DIV1, DIV3, DIV4, SCC) comprising a shared circuit (DIV1) via which both branches receive the oscillator signal. This allows the oscillator, which provides the oscillator signal, to have a modest load, which contributes to a stable operation.

The aforementioned characteristics can be implemented in numerous different manners. In order to illustrate this, some alternatives are briefly indicated. The frequency-division factor of the basic-frequency branch can be equal to 1, in which case there is no frequency division in this branch. For example, referring to FIG. 10, the controllable oscillator VCO and divider DIV1 may be replaced by a quadrature oscillator that oscillates at a frequency of 3960 MHz and that provides a quadrature output signal. The frequency-division factor of the basic-frequency branch may be an odd-integer value or a non-integer value, such as, for example, 1.5. The frequency-division factor of the offset frequency branch may be an even-integer value or a non-integer value.

The controllable frequency converter need not comprise a single-side-band mixer, which receives quadrature input signals, although this is advantageous. The controllable frequency converter may comprise, for example, a single mixer circuit only and one or more filters for suppressing image-frequency signals and other spurious signals. A tunable filter may be used, for example, to select the appropriate frequency for the frequency-hopping signal among various different frequencies. In such an implementation, the frequency selection circuit, which is illustrated in FIG. 6, is not required. Quadrature signals are not required either.

In the linear combination of the basic frequency and the offset frequency, respective coefficients may have values other than −1, 0, 1. For example, a coefficient may be equal to 2 or 3. A coefficient, whose absolute value is greater than 1, corresponds with a harmonic of the signal of interest. A filter may be used to select a desired harmonic in the basic frequency signal or the offset frequency signal. Two filters allow harmonic selection in both signals. It should further be noted that one or the other coefficient, or both coefficients in the linear combination may vary as a function of the hopping-control signal.

The frequency-hopping arrangement can be applied in systems other than a direct-conversion system, although a direct-conversion system is advantageous. Frequency dividers may be different from those illustrated in FIGS. 7 and 8. These are merely examples. A frequency divider having a particular frequency-division factor can generally be implemented in numerous different manners. For example, there are various different circuits that provide a divide-by-3 frequency division, even if a 50% duty cycle output signal is required.

There are numerous ways of implementing functions by means of items of hardware or software, or both. In this respect, the drawings are very diagrammatic, each representing only one possible embodiment of the invention. Thus, although a drawing shows different functions as different blocks, this by no means excludes that a single item of hardware or software carries out several functions. Nor does it exclude that an assembly of items of hardware or software or both carry out a function.

The remarks made herein before demonstrate that the detailed description with reference to the drawings, illustrate rather than limit the invention. There are numerous alternatives, which fall within the scope of the appended claims. Any reference sign in a claim should not be construed as limiting the claim. The word “comprising” does not exclude the presence of other elements or steps than those listed in a claim. The word “a” or “an” preceding an element or step does not exclude the presence of a plurality of such elements or steps.

1. A frequency-hopping arrangement (WLC) comprising:
a basic-frequency branch (DIV1) for receiving an oscillator signal (OS) having an oscillator-signal frequency, the basic-frequency branch having a frequency-division factor for providing a basic-frequency signal (BF) having a basic frequency, which is the oscillator-signal frequency divided by the frequency-division factor;
an offset-frequency branch (DIV2, DIV3, SCC) for receiving the same oscillator signal, the offset-frequency branch having a different frequency-division factor for providing an offset-frequency signal (OF) having an offset frequency, which is the oscillator-signal frequency divided by the different frequency-division factor; and
a controllable frequency converter (SBM, FSC) for providing a frequency-hopping signal (FHS) having a frequency, which is a linear combination of the basic frequency and the offset frequency with at least one coefficient (c2) that varies as a function of a hopping-control signal (HCS).

2. A frequency-hopping arrangement as claimed in claim 1, the offset-frequency branch (DIV2, DIV3, SCC) providing the offset-frequency signal (OF) in the form of a quadrature signal having an in-phase component (OFi) and a quadrature component (OFq), the controllable frequency converter (SBM, FSC) comprising:
a frequency selector (FSC) for providing a mixer-input signal (RF), which corresponds to the offset-frequency signal (OF) when the hopping-control signal (HCS) is in a non-inverting state, and which corresponds to the offset-frequency signal with the in-phase and quadrature component being interchanged when the hopping-control signal is in an inverting state; and
a quadrature mixer (SBM) for mixing the mixer-input signal with the basic frequency signal (BF).

3. A frequency-hopping arrangement as claimed in claim 2, the frequency selector (FSC) providing a direct-current signal as the mixer-input signal (HF) when the hopping-control signal (HCS) is in a neutral state.

4. A frequency-hopping arrangement as claimed in claim 2, the basic-frequency branch (DIV1) providing the basic-frequency signal (BF) in the form of a quadrature signal having an in-phase component (BFi) and a quadrature component (BFq), the controllable frequency converter (SBM, FSC) comprising a pair of quadrature mixers (SBM) for mixing the mixer-input signal (HF) with the basic frequency signal.

5. A frequency-hopping arrangement as claimed in claim 2, the offset-frequency branch (DIV2, DIV3, SCC) providing the offset-frequency signal (OF) with a fifty percent duty cycle.

6. A frequency-hopping arrangement as claimed in claim 2, the offset-frequency branch (DIV2, DIV3, SCC) comprising:
an input circuit (DIV2) for providing a frequency-divided signal (DA) with a fifty percent duty cycle on the basis of the oscillator signal (OS); and
an output circuit (DIV3, SCC) for providing the offset frequency signal (OF), which has the in-phase component (OFi) and the quadrature component (OFq), on the basis of the frequency-divided signal (DA).

7. A frequency-hopping arrangement as claimed in claim 1, comprising:
a controllable oscillator (VCO) for providing the oscillator signal (OS);
a phase-lock loop circuit (PLL) for synchronizing the oscillator signal with a reference-frequency signal (CKR).

8. A frequency-hopping arrangement as claimed in claim 1, the basic-frequency branch (DIV1) and the offset-frequency branch (DIV1, DIV3, DIV4, SCC) comprising a shared circuit (DIV1) via which both branches receive the oscillator signal.

9. A method of frequency-hopping that employs a frequency-hopping arrangement as claimed in claim 1, the method comprising:
a frequency-hopping control step (CTRL) in which the hopping-control signal (HCS) is applied to the controllable frequency converter (SBM, FSC) so as to vary the at least one coefficient (c2) in the linear combination of the basic frequency and the offset frequency.

10. A wireless-link system (WPAN) comprising an antenna (ANT) and a frequency-hopping arrangement as claimed in claim 1, for establishing a wireless link (WL1, WL2), which successively hops from one to another frequency band in a group of frequency bands (B1, B2, B3) as a function of the frequency-hopping signal (HCS).

11. An information-rendering apparatus (PC) comprising an antenna (ANT) and a frequency-hopping arrangement as claimed in claim 1, for establishing a wireless link (WL2) that successively hops from one to another frequency band in a group of frequency bands (B1, B2, B3) as a function of the frequency-hopping signal (HCS), and a rendering device (DPL) arranged to render data (DT) received via the wireless link.
